(19) United States
(12) Patent Application Publication
(10) Pub. No.: US 2015/0171421 A1
(43) Pub. Date: Jun. 18, 2015

(54) ELECTRODE FOR LITHIUM ION SECONDARY CELL, METHOD FOR PREPARING PASTE FOR SAID ELECTRODE AND METHOD FOR MANUFACTURING SAID ELECTRODE

(71) Applicant: MITSUBISHI MATERIALS CORPORATION, Tokyo (JP)

(72) Inventors: Jun Akikusa, Mito-shi (JP); Shigenari Yanagi, Toukai-mura (JP); Kenzo Nakamura, Toukai-mura (JP); Shin Tsuchiya, Saitama-shi (JP)

(73) Assignee: MITSUBISHI MATERIALS CORPORATION, Tokyo (JP)

(21) Appl. No.: 14/400,412

(22) PCT Filed: May 17, 2013
(86) PCT No.: PCT/JP2013/063741

§ 371 Date: Nov. 11, 2014

(30) Foreign Application Priority Data
May 31, 2012 (JP) 2012-124914

(51) Int. Cl. H01M 4/36; H01M 4/525; H01M 4/04; H01M 4/131; H01M 4/133; H01M 4/587; H01M 4/62; H01M 4/505

(52) U.S. Cl. CPC H01M 4/366; H01M 4/623; H01M 4/525; H01M 4/505; H01M 4/131; H01M 4/133; H01M 4/587; H01M 4/043; H01M 4/0402

(57) ABSTRACT

An electrode for a lithium ion secondary cell includes a conductive auxiliary agent, a binder and an active material. The conductive auxiliary agent includes carbon black and carbon nanofibers. The carbon nanofibers are configured to electrically crosslink the active material and the carbon black so that the carbon nanofibers coat part or all of a surface of the active material to be secured by a binder. In addition, by defining the entire surface of the active material as 100%, 10 to 100% of the surface of the active material is coated with the carbon nanofibers. By bonding the carbon black to the carbon nanofibers with which the surface of the active material is coated, the active material and the carbon black are electrically crosslinked.

### TECHNICAL FIELD

The present invention relates to an electrode for a lithium ion secondary cell, a method for preparing a paste for the electrode, and a method for manufacturing the electrode.

### BACKGROUND ART

Conventional technologies disclose an electrode comprising a current collector and an active material layer arranged on the current collector, wherein the active material layer comprises an active material composition and a net-meshing structure, and the net-meshing structure comprises carbon nanotubes and a binder (e.g. see Patent Document 1). In the electrode, the net-meshing structure further comprises a dispersing agent, and the carbon nanotubes forming the net-meshing structure are electrically connected with each other. In addition, the net-meshing structure is configured to have a mesh form and be contained inside an active material layer to play a role as a kind of skeleton. Additionally, the net-meshing structure is preferably arranged as a conductive layer between a current collector and a layer comprising an active material composition. When a conductive layer is present as a separate layer that is different from an active material layer, the conductive layer plays a role in binding an active material composition layer and a current collector. When the conductive layer is removed after mixing with the active material layer, the active material composition in the process of electrode production is present such that it extends toward the inside of the net-meshing structure of the conductive layer.

Moreover, a battery electrode mixture comprising a positive electrode active material, a binder and a conductivity imparting agent, wherein the conductivity imparting agent is a carbonaceous material containing a carbon nanotube or a carbonaceous material containing a carbon nanotube including a metal ion, is disclosed (e.g. Patent Document 2). In the battery electrode mixture, the positive electrode active material is manganese dioxide or lithium transition metal oxide. In the battery electrode mixture thus configured, since a carbon nanotube-containing carbon material or a carbon nanotube including a metal ion-containing carbon material as a conductivity imparting agent is added to and mixed with such as manganese dioxide and lithium transition metal oxide as a positive electrode active material, electronic conductivity can be improved.

In addition, a positive electrode active material for a lithium secondary cell comprising an assembly of a fine porous carbonaceous material and a lithium complex compound and a carbon layer formed on a surface of the assembly is disclosed (e.g. Patent Document 3). In the positive electrode active material for a lithium secondary cell, the mixing ratio of the lithium complex compound to the fine porous carbonaceous material ranges from 99:1% by mass to 70:30% by mass, and the positive electrode active material further comprises a conductive material. In addition, the conductive material is carbon black, a carbon nanotube, carbon nanofibers, vapor phase epitaxy carbon fibers (VGCF), a carbon powder, a graphite powder, or a combination of these. In the positive electrode active material for a lithium secondary cell thus configured, if the content of the conductive material is set at approx. 1 part by mass to approx. 5 parts by mass relative to 100 parts by mass of the positive electrode active material, an appropriate level of conductivity can be imparted.

Further, a positive electrode formation material comprising a particle of a positive electrode active material and fine carbon fibers adhered on a particle surface of the positive electrode active material in mesh form is disclosed (e.g. Patent Document 4). In the positive electrode formation material, the positive electrode active material is a particulate whose average particle diameter is 0.03 μm to 40 μm. The fine carbon fibers are carbon nanofibers whose average fiber diameter is 1 nm to 100 nm and whose aspect ratio is 5 or more. Further, a surface of the carbon nanofibers is subjected to oxidation treatment. Since the positive electrode formation material thus configured is capable of forming a positive electrode adhered after the carbon nanofibers as fine carbon fibers are dispersed on a particle surface of the positive electrode active material in mesh form, conductivity of the positive electrode can be improved and cell output can be raised by using a relatively small amount of carbon fibers. In addition, since a surface of the carbon nanofibers as the above fine carbon fibers is hydrophilized due to oxidation treatment, the nanofibers are favorably dispersed in an aqueous solution. As a result, a dispersing agent is not required, resulting in no gas generation from decomposition of the dispersing agent to form a positive electrode excellent in output performance. In addition to carbon nanofibers as fine carbon fibers, a finer carbon powder than a positive electrode active material such as carbon black whose average primary particle diameter is 10 nm can be used. Thus, the fine carbon powder enters a void between particles of the positive electrode active material to further improve conductivity.

### PRIOR ART REFERENCES

### Patent Documents

Patent Document 1: Japanese Unexamined Patent Application Publication No. 2009-170410 (claims 1 to 3, paras. [0011] and [0020])

Patent Document 2: Japanese Unexamined Patent Application Publication No. 07-014582 (claims 1 and 2, para. [0011])

Patent Document 3: Japanese Unexamined Patent Application Publication No. 2011-238586 (claims 1 and 6 to 8, para. [0027])

Patent Document 4: Japanese Unexamined Patent Application Publication No. 2008-270204 (claims 1 and 2, paras. [0010], [0011]and [0027])

### SUMMARY OF THE INVENTION

### Problems to be Solved by the Invention

However, the electrode shown in the above conventional Patent Document 1 unfortunately fails to describe a specific bond structure composed of an active material composition and a net-meshing structure, particularly a specific bond structure composed of an active material composition and carbon nanotubes. Therefore, there was a problem of reduced conductivity of an electrode according to how to bond the active material composition and the carbon nanotubes. In addition, the battery electrode mixture shown in the above conventional Patent Document 2 fails to describe a specific bond structure composed of a positive electrode active material and a conductivity imparting agent, particularly a specific bond structure composed of a positive electrode active material and a carbon nanotube-containing carbon material. Thus, electrode conductivity is unfortunately reduced according to how to bond the positive electrode active material and the carbon nanotube-containing carbon material. Moreover, the positive electrode active material for a lithium secondary cell shown in the above conventional Patent Document 3 fails to describe a specific bond structure composed of a positive electrode active material and a conductive material, particularly a specific bond structure composed of a positive electrode active material and carbon nanotubes. Thus, positive electrode conductivity is unfortunately reduced according to how to bond the positive electrode active material and the carbon nanotubes. Further, the positive electrode formation material shown in the above conventional Patent Document 4 has a problem: by using carbon black as a finer carbon powder than a positive electrode active material in addition to carbon nanofibers, the carbon black having a lower conductivity than the carbon nanofibers enters a void between particles of the positive electrode active material. Consequently, since the carbon black adheres to the positive electrode active material from a mesh of the carbon nanofibers adhered to a surface of the positive electrode active material in relatively large quantities, conductivity of the entire positive electrode can be reduced.

The objective of the present invention is to provide an electrode for a lithium ion secondary cell, a method for preparing a paste for the electrode and a method for manufacturing the electrode capable of preparing a significantly favorable electrical path to improve cell performance such that carbon nanofibers electrically crosslink an active material and carbon black.

### Means for Solving the Problem

A first aspect of the present invention is characterized in that in an electrode for a lithium ion secondary cell comprising a conductive auxiliary agent, a binder and an active material, wherein the conductive auxiliary agent comprises carbon black and carbon nanofibers, wherein the carbon nanofibers are configured to electrically crosslink the active material and the carbon black, and the carbon nanofibers coat part or all of a surface of the active material to be secured by the binder.

A second aspect of the present invention is an invention according to the first aspect, further, by defining the entire surface of the active material as 100%, 10 to 100% of a surface of the active material is coated with carbon nanofibers and the active material and the carbon black are electrically crosslinked by bonding the carbon black to the carbon nanofibers with which the surface of the active material is coated.

A third aspect of the present invention is an invention according to the first aspect, further, the carbon black is acetylene black.

A fourth aspect of the present invention is an invention according to the first aspect, further, the binder is polyvinylidene fluoride.

A fifth aspect of the present invention is an invention according to the first aspect, further, the active material is a positive electrode active material composed of any of LiCoO₂, LiMn₂O₄, LiNiO₂, LiFePO₄ and Li(MnₓNi_{y}Co_{z})O₂, wherein X, Y and Z in the Li(MnₓNi_{y}Co_{z})O₂ meet the following conditions: X+Y+Z=1 and 0<X<1, 0<Y<1 and 0<Z<1.

A sixth aspect of the present invention is an invention according to the first aspect, further, the active material is a negative electrode active material composed of graphite.

A seventh aspect of the present invention is a method for preparing a paste for an electrode of a lithium ion secondary cell, comprising the steps of: preparing a viscous binder paste by adding a solvent or a thickener to a binder; dispersing each powder of carbon black, carbon nanofibers and an active material in the binder paste by simultaneously adding each powder thereof to the binder paste, by stirring the same with a mixer that acts no shearing force on each powder thereof and by further stirring the same with a homogenizer that acts no shearing force on each powder thereof; and preparing a paste for an electrode by dispersing an aggregate of a residue of each powder thereof in the above binder paste by stirring the same with a homogenizer that acts a shearing force on each powder thereof dispersed in the binder paste.

A eighth aspect of the present invention is a method for preparing a paste for an electrode of a lithium ion secondary cell, comprising the steps of: preparing a mixed powder by stirring carbon black, carbon nanofibers, a binder and an active material in the form of a powder with a planetary mixer; and preparing a paste for an electrode in which each powder of the active material, the carbon black and the carbon nanofibers is uniformly dispersed by dissolving the binder in a solvent by stirring the mixed powder with a planetary mixer while feeding the solvent to the mixed powder in small quantities.

A ninth aspect of the present invention is a method for manufacturing an electrode of a lithium ion secondary cell, comprising the steps of: forming an electrode film formed on an electrode foil by applying the paste for an electrode prepared by the method according to the seventh aspect to the electrode foil; forming the electrode film so as to have a constant thickness; drying the electrode film formed to have a constant thickness; and manufacturing a sheet-like electrode by pressing the dried electrode film.

A tenth aspect of the present invention is a method for preparing an electrode of a lithium ion secondary cell, comprising the steps of: forming an electrode film on an electrode foil by applying the paste for an electrode prepared by the method according to the eighth aspect to the electrode foil; forming the electrode film so as to have a constant thickness; drying the electrode film formed to have a constant thickness; and manufacturing a sheet-like electrode by pressing the dried electrode film.

### EFFECTS OF THE INVENTION

In the electrode of the lithium ion secondary cell of the first aspect of the present invention, a conductive auxiliary agent comprises carbon black and carbon nanofibers. Since the carbon nanofibers electrically crosslink an active material and the carbon black, an electrical network is provided from the active material to an electrode foil (current collector) via the carbon nanofibers and the carbon black. As a result, a significantly favorable electrical path is prepared in the electrode to improve cell performance.

In the electrode of the lithium ion secondary cell of the second aspect of the present invention, carbon nanofibers coat 10 to 100% of a surface of an active material, and by bonding carbon black to the carbon nanofibers with which the surface of the active material is coated, the active material and the carbon black are electrically crosslinked, thereby making the carbon black having a lower adhesion property than the carbon nanofibers coat little or does not coat surface of the active material. As a result, an electrical network from the active material to an electrode foil via the carbon nanofibers and the carbon black is partially or entirely prepared, and consequently an electrical network from the active material to the electrode foil via the carbon black (i.e. by bypassing the carbon nanofibers) is reduced or removed. Accordingly, like the above case, a significantly favorable electrical path is prepared in an electrode to improve cell performance.

In a method for preparing a paste for an electrode of a lithium ion secondary cell according to the seventh aspect of the present invention, each powder of carbon black, carbon nanofibers and an active material is dispersed in a binder by simultaneously adding each powder thereof to a binder paste, by stirring the same with a mixer that acts no shearing force on each powder thereof, by stirring the same with a homogenizer that acts no shearing force on each powder thereof, and by further stirring the same with a homogenizer that acts a shearing force on each powder thereof. Consequently, each powder is dispersed in the binder paste and an aggregate of a residue of each powder thereof is dispersed in the binder paste. Therefore, the carbon nanofibers that can more readily adhere to a solid surface than the carbon black adhere to part or all of a surface of the active material to be secured by the binder. As a result, the carbon nanofibers electrically crosslink the active material and the carbon black, thereby preparing a significantly favorable electrical path in the electrode and to improve cell performance.

In the method for preparing a paste for an electrode of a lithium ion secondary cell according to the eighth aspect of the present invention, by stirring carbon black, carbon nanofibers, a binder and an active material in the form of a powder with a planetary mixer, a mixed powder is prepared. The binder is dissolved in a solvent by stirring each powder thereof with a planetary mixer while feeding the solvent to the mixed powder to uniformly disperse each powder of the active material, the carbon black and the carbon nanofibers in the solvent. Consequently, the carbon nanofibers that can more readily adhere to a solid surface than the carbon black adhere to part or all of a surface of the active material to be secured by the binder. As a result, the carbon nanofibers electrically crosslink the active material and the carbon black, thereby preparing a significantly favorable electrical path in the electrode to improve cell performance.

### BRIEF DESCRIPTION OF THE DRAWINGS

FIG. 1 is a photographic image of part of a cross-section of a positive electrode of Example 1 of the present invention taken by scanning electron microscope (SEM) ; and

FIG. 2 is a photographic image of part of a cross-section of a positive electrode of Comparative Example 1 taken by scanning electron microscope (SEM).

### BEST MODES FOR CARRYING OUT THE INVENTION

Next, an embodiment for carrying out the present invention will be described. An electrode of a lithium ion secondary cell comprises an electrode film comprising a conductive auxiliary agent, a binder and an active material, and an electrode foil having the electrode film formed on a surface thereof. The conductive auxiliary agent comprises carbon black and carbon nanofibers, and the carbon nanofibers are configured to electrically crosslink the active material and the carbon black by coating part or all of a surface of the active material to be secured by the binder. Illustrative example of the carbon black includes acetylene black (AB). The carbon black is preferably a powder whose average primary particle is 30 to 200 nm. Herein, the validity of limiting the average primary particle of the carbon black to a range of 30 to 200 nm is described. When the average primary particle is under 30 nm, carbon black that plays a role as a bus bar (conducting bar) is subjected to insufficient conductivity in view of electric conduction property, and when the average primary particle exceeds 200 nm, a weaker bond between particles of the carbon black leads to insufficient conductivity as well. Meanwhile, the carbon nanofibers contain carbon nanotubes. It is preferable that in the carbon nanofibers, the average fiber outer diameter be 10 to 30 nm and the aspect ratio be 50 or more. Herein, the average fiber outer diameter of the carbon nanofibers is limited to a range of 10 to 30 nm because the electronic conductivity of the carbon nanofibers is reduced with an average fiber outer diameter of under 10 nm and when it is over 30 nm, the property of the carbon nanofibers to be tangled with the active material is reduced. The aspect ratio of the carbon nanofibers is limited to 50 or more because the length of the carbon nanofibers that play a role in crosslinking the active material and the carbon black is too short when the ratio is under 50.

Illustrative example of the binder includes polyvinylidene fluoride (PVDF) having an organic solvent as a solvent, or a styrene-butadiene rubber (SBR) having water as a solvent. When the binder is polyvinylidene fluoride, an organic solvent such as N-methylpyrrolidone (NMP) is used as a solvent. The organic solvent is evaporated during a drying process and provides no residue in an electrode. When the binder is a styrene-butadiene rubber, carboxymethyl cellulose (CMC) is added as a thickener. Since the thickener does not evaporate even in a dry state, it resides in the electrode. Meanwhile, when the electrode is a positive electrode, illustrative example of the active material includes a positive electrode active material composed of any of LiCoO₂, LiMn₂O₄, LiNiO₂, LiFePO₄ and Li(MnₓNi_{y}CO_{z})O₂ and when an electrode is a negative electrode, illustrative example of the active material includes a negative electrode active material composed of graphite such as natural graphite and artificial graphite. However, X, Y and Z in Li(MnₓNi_{y}CO_{z})O₂ meet the following conditions: X+Y+Z=1 and 0<X<1, 0<Y<1 and 0<Z<1. The average particle diameter of the active material is preferably 0.1 to 15 μm. Herein, the average particle diameter of the active material is limited to a range of 0.1 to 15 μm because characteristics on viscoelasticity, fluidity and deformation (known as rheology) of a paste for an electrode when manufacturing an electrode significantly change when it is under 0.1 μm to sharply deteriorate handling performance in a process for coating a paste for an electrode and generate irregularities on an electrode film surface formed on an electrode foil when it exceeds 15 μm. The average primary particle diameter of the above carbon black and the average particle diameter of the active material are measured with 1G-1000 (single nanoparticle size measuring device: a product manufactured by Shimazu Corporation) by dispersing carbon black in an NMP solvent (N-methylpyrrolidone solvent) at 20° C. so that a solution used is 3% by mass. The standard volume-weighted mean diameter corresponds to the average primary particle diameter of the carbon black and the average particle diameter of the active material. As for the average fiber outer diameter of the carbon nanofibers, the outer diameters of 30 carbon nanofibers are each measured by transmission electron microscope (TEM) and average values thereof are defined as the average fiber outer diameter of the carbon nanofibers. Further, as for the aspect ratio of the carbon nanofibers, the outer diameters and lengths of 30 carbon nanofibers are each measured by transmission electron microscope (TEM) and average values thereof are defined as the aspect ratio of the carbon nanofibers.

By defining the entire surface of an active material as 100%, 10 to 100%, preferably 30 to 100% of a surface of the active material is coated with the carbon nanofibers. Carbon black is bonded to the carbon nanofibers with which the surface of the active material is coated. Accordingly, the carbon nanofibers electrically crosslink the active material and the carbon black. Herein, the validity of limiting the ratio of coating a surface of the active material with carbon nanofibers in a range of 10 to 100% is described. When the ratio is under 10%, there is too small bonding portion of the carbon nanofibers and the active material, thereby increasing electric resistance, i.e. there is relatively a large portion of a surface of the active material that is not coated with the carbon nanofibers. More specifically, a less conductive carbon black than the carbon nanofibers is secured to the large surface of the active material to coat the surface of the active material with the carbon black and to reduce conductivity of an electrical path prepared in an electrode.

A first method for preparing a paste used in manufacturing the electrode thus configured (a paste for an electrode) will be described. First, a viscous binder paste is prepared by adding a solvent or thickener to a binder. When polyvinylidene fluoride having an organic solvent as a solvent is used as a binder, an organic solvent such as N-methylpyrrolidone is added. Accordingly, a solid binder is dissolved in the organic solvent to provide a viscous binder paste. When a styrene-butadiene rubber is used as a binder having water as a solvent, a thickener such as carboxymethyl cellulose is added. Accordingly, viscosity is imparted to the binder to provide a viscous binder paste. Although the viscosity of the paste significantly varies according to a coating ratio of a paste on a current collector, it is normally about 0.1 Pa·sec to 12 Pa·sec. Next, after each powder of carbon black, carbon nanofibers and an active material is simultaneously added to the above binder paste and stirred with a mixer that acts no shearing force on each powder thereof, each powder thereof is further stirred with a homogenizer that acts no shearing force on each powder thereof to disperse each powder thereof in the binder paste. Further, by stirring each powder thereof dispersed in the above binder paste with a homogenizer that acts shearing force on each powder thereof, an aggregate of each powder thereof residing in the binder paste is dispersed to prepare a paste for an electrode. Accordingly, the carbon nanofibers having a property of more readily adhering to a solid surface than the carbon black coat part or all of a surface of the active material to be secured by the binder. As a result, the carbon nanofibers electrically crosslink the active material and the carbon black, thereby preparing a significantly favorable electrical path in an electrode to improve cell performance.

The mixer that acts no shearing force on each powder refers to an agitator for uniformly dispersing each powder in a binder paste without shearing by simultaneous processing of stirring and defoaming using two types of centrifugal forces (rotation and revolution of a container itself) having no rotating blade like Awatori Rentarou (product name of a mixer manufactured by THINKY Corporation). A homogenizer comprises a cylindrical fixed outer blade provided with a plurality of windows and a plate rotary inner blade that rotates in the fixed outer blade. When the rotary inner blade rotates in the binder paste at a high speed, a paste in the fixed outer blade is strongly and radially sprayed from the window by a centrifugal force. Meanwhile, the paste enters the fixed outer blade from an open end face of the fixed outer blade to generate strong convection, and each powder enters the convection to disperse or pulverize itself in the paste. A homogenizer that acts no shearing force on each powder refers to a homogenizer that only disperses a powder without shearing the same by setting a larger gap between the fixed outer blade and the rotary inner blade. A homogenizer that acts a shearing force on each powder refers to a homogenizer that shears and pulverizes an aggregate of a powder between the fixed outer blade and the rotary inner blade as well as dispensing the powder by setting a smaller gap between the fixed outer blade and the rotary inner blade.

When polyvinylidene fluoride is used as a binder having an organic solvent as a solvent, the ratios of mixing carbon black, carbon nanofibers, a binder and an active material are 1 to 7% by mass, 0.1 to 5% by mass, 2 to 7% by mass, and the balance, respectively, relative to 100% by mass of an electrode film (total amount of a paste for an electrode except for an organic solvent). The organic solvent is preferably mixed at 30 to 60% by mass relative to 100% by mass of an electrode film (total amount of a paste for an electrode except for an organic solvent). Herein, the validity of limiting the mixing ratio of the carbon black to a range of 1 to 7% by mass is described. When the ratio is under 1% by mass, the ratio of a conductive path as a bus bar (conducting bar) borne by the carbon black becomes smaller and when the ratio exceeds 7% by mass, the resulting larger content of the carbon black generates many voids inside when preparing a mixture with a binder to expand. The mixing ratio of the carbon nanofibers is limited to a range of 0.1 to 5% by mass because the extent of entanglement of the carbon nanofibers with the active material is reduced when the ratio is under 0.1% by mass, and the carbon nanofibers tangle with each other to agglomerate the carbon nanofibers when the ratio exceeds 5% by mass. The mixing ratio of the binder is limited to a range of 2 to 7% by mass because the adhesion property of the active material and the current collector becomes weaker when the ratio is under 2% by mass and the content of polyvinylidene fluoride having little electronic conductivity becomes larger to reduce electric conduction when the ratio exceeds 7% by mass. Further, the mixing ratio of the organic solvent is limited to a range of 30 to 60% by mass because the viscosity of a paste for an electrode becomes so high that a paste for an electrode cannot be coated when the ratio is under 30% by mass and the viscosity of a paste for an electrode becomes so low that a paste for an electrode cannot be coated when the ratio exceeds 60% by mass.

On the other hand, when the styrene-butadiene rubber is used as a binder having water as a solvent, the ratios of mixing carbon black, carbon nanofibers, a binder, a thickener and an active material are 1 to 7% by mass, 0.1 to 5% by mass, 0.5 to 2.5% by mass, 0.5 to 2.5% by mass and the balance, respectively, relative to 100% by mass of an electrode film (total amount of a paste for an electrode except for an organic solvent). The moisture is preferably mixed at a ratio of 30 to 60% by mass relative to 100% by mass of an electrode film (total amount of a paste for an electrode except for an organic solvent). Herein, limiting the mixing ratio of carbon black to a range of 1 to 7% by mass is based on the same reason as described above. In addition, limiting the mixing ratio of carbon nanofibers to a range of 0.1 to 5% by mass is based on the above reason. Limiting the mixing ratio of the binder to a range of 0.5 to 2.5% by mass is based on the fact that the adhesiveness of the active material and the current collector becomes weaker when the ratio is under 0.5% by mass and the content of the styrene-butadiene rubber having little electronic conductivity becomes larger to reduce electric conduction when the ratio exceeds 2.5% by mass. In addition, the mixing ratio of the thickener is limited to a range of 0.5 to 2.5% by mass because the viscosity of a paste for an electrode becomes too low when the ratio is under 0.5% by mass and the viscosity of a paste for an electrode becomes too high when the ratio exceeds 2.5% by mass. Further, limiting the mixing ratio of moisture to a range of 30 to 60% by mass is based on the fact that the viscosity of a paste for an electrode becomes too high to coat a paste for an electrode when the ratio is under 30% by mass, and the viscosity of a paste for an electrode becomes too low to coat a paste for an electrode when the ratio exceeds 60% by mass.

Next, a second method for preparing a paste for an electrode is described. First, carbon black, carbon nanofibers, a binder and an active material are stirred in the form of a powder with a planetary mixer to prepare a mixed powder. Subsequently, a solvent is fed to the above mixed powder in small quantities. The mixed powder is stirred with a planetary mixer to dissolve a binder in a solvent and prepare a paste for an electrode in which each powder of the active material, the carbon black and the carbon nanofibers is uniformly dispersed. Accordingly, the carbon nanofibers having a property of more readily adhering to a solid surface than the carbon black coat part or all of a surface of the active material to be secured by the binder. As a result, the carbon nanofibers electrically crosslink the active material and the carbon black, thereby preparing a significantly favorable electrical path in an electrode to improve cell performance. In addition, the planetary mixer comprises a tank and two frame-shaped blades that rotate in the tank. Planetary movement of the blades provides a significantly small dead space between the blades and another small dead space between the blades and an inner surface of the tank to act a powerful shearing force on each powder in the binder paste. Accordingly, a powder is dispersed and an aggregate of the powder is pulverized by the above shearing force. The carbon black, the carbon nanofibers, the binder, the active material, and so on are mixed with the same mixing ratios as in the above first method.

A method for manufacturing an electrode using the paste for an electrode thus manufactured is described. First, the paste for an electrode prepared in the above method is applied on an electrode foil (current collector) to form an electrode film on the electrode foil. Herein, when the electrode is a positive electrode, the electrode foil is an aluminum foil, and when the electrode is a negative electrode, the electrode foil is a copper foil. Next, the above electrode film is formed so as to have a constant thickness using an applicator (gap is approx. 50 μm). Next, the electrode foil having an electrode film having a constant thickness is placed in a drier to be left at 100 to 140° C. for 5 minutes to 2 hours. Thereafter, an organic solvent or moisture is evaporated to dry the electrode film. Further, the dried electrode film is pressed with a press so that the porosity becomes 20 to 50% to manufacture a sheet-like electrode. Herein, limiting the drying temperature of the electrode film to a range of 100 to 140° C. is based on the fact that there may be more drying duration under 100° C. and polyvinylidene fluoride is subjected to thermal decomposition over 140° C. In addition, the drying duration of the electrode film is limited to a range of 5 minutes to 2 hours because there may be insufficient drying of the electrode film when the duration is under 5 minutes, and the electrode film becomes too solidified when the duration exceeds 2 hours. Further, the porosity of the electrode film is limited to a range of 20 to 50% because it is hard for an electrolyte to get into an electrode film when the ratio is under 20% and the free space grows to reduce the cell capacity per volume when the ratio exceeds 50%.

In the electrode thus manufactured, a conductive auxiliary agent comprises carbon black and carbon nanofibers, and the carbon nanofibers electrically crosslink the active material and the carbon black, thereby providing an electrical network from the active material to the electrode foil (current collector) via the carbon nanofibers and the carbon black. As a result, a significantly favorable electrical path is prepared in an electrode to improve lithium ion secondary cell performance. Specifically, 10 to 100% of a surface of the active material is coated with the carbon nanofibers and the carbon black is bonded to the carbon nanofibers with which the surface of the active material is coated to electrically crosslink the active material and the carbon black. Thus, the carbon black having a lower adhesiveness than the carbon nanofibers coats little or does not coat the surface of the active material. As a result, part or all of the electrical network from the active material to the electrode foil via the carbon nanofibers and the carbon black is provided to reduce or remove an electrical network that bypasses the carbon nanofibers and leads directly to the electrode foil from the active material via the carbon black. Therefore, as in the above case, a significantly favorable electrical path is prepared in an electrode to improve lithium ion secondary cell performance.

### EXAMPLES

Next, Examples of the present invention will be described in detail as well as Comparative Examples.

### Example 1

First, an N-methylpyrrolidone (NMP) as an organic solvent was added to a polyvinylidene fluoride (PVDF) as a binder having an organic solvent as a solvent to prepare a viscous binder paste. Each powder of an acetylene black (AB), carbon nanofibers (CNF) and a positive electrode active material (LiFePO₄(LFP)) was simultaneously added to the binder paste, stirred with Awatori Rentarou (product name of a mixer manufactured by THINKY Corporation) for 5 minutes, and the mixed powder was further stirred with a homogenizer that acts no shearing force on each powder thereof for 5 minutes. Subsequently, the mixed powder was stirred with a homogenizer that acts a shearing force on each powder dispersed in the above binder paste for 5 minutes to prepare a paste for an electrode. Herein, the mixing ratios of the acetylene black (AB), the carbon nanofibers (CNF), the polyvinylidene fluoride (PVDF) and the positive electrode active material (LiFePO₄(LFP)) were 5% by mass, 3% by mass, 5% by mass and 87% by mass, respectively, relative to 100% by mass of an electrode film (total amount of a paste for an electrode except for an organic solvent). Next, the above paste for an electrode was applied on an aluminum foil (current collector) to form an electrode film on the aluminum foil. The above electrode film was formed so as to have a constant thickness using an applicator (gap: 50 μm). The electrode foil having an electrode film having a constant thickness was placed in a drier to be left at 130° C. for 1 hour to manufacture a sheet-like electrode by evaporating the organic solvent and drying the electrode film. The electrode was taken as Example 1. A homogenizer that acts a shearing force was Filmix Model 30-30 (Product from PRIMIX Corporation), rotated at a rotational speed of 11,000 rpm (linear speed: 15 m/sec). The outer diameter, height and wall thickness of an inner blade of a rotor shape inside Filmix Model 30-30 were 26 mm, 20 mm and 1 mm, respectively. The internal diameter and height of a container containing an inner blade of the rotor shape were 30 mm and 22 mm, respectively. The gap between the container and the inner blade of the rotor shape was 2 mm. It is configured that a shearing stress acts thereon and an aggregate of an acetylene black (AB) and carbon nanofibers (CNF) is dispersed thereon.

### Comparative Example 1

The mixed powder was not stirred with a homogenizer that acts shearing force on each powder dispersed in a binder paste. Other conditions were the same as in Example 1 to manufacture a sheet-like electrode. The electrode was taken as Comparative Example 1.

### Comparative Example 2

A powder of the carbon nanofibers (CNF) was not added to a binder paste, and only each powder of the acetylene black (AB) and the positive electrode active material (LiFePO₄(LFP)) was simultaneously added. Other conditions were the same as in Example 1 to manufacture a sheet-like electrode. The electrode thus manufactured was taken as Comparative Example 2.

### Comparative Test 1 and Evaluation

After the sheet-like electrodes of Example 1, Comparative Examples 1 and 2 were into a square plate (10 cm by 10 cm), positive electrodes were manufactured by pressing so that the porosity of an electrode film on an electrode foil was 35%. Next, lithium plate 0.25 mm thick was cut out into a square plate (10 cm by 10 cm) to manufacture a counter electrode (or a negative electrode). Next, a separator composed of a laminated structure obtained by sandwiching a polyethylene sheet with two polypropylene sheets was cut out in the form larger than the positive electrode. The separator was sandwiched with the positive electrode and the counter electrode. Further, a solution obtained by dissolving a 1M lithium hexafluorophosphate in a solvent obtained by mixing ethylene carbonate (EC: ethylene carbonate) and diethyl carbonate (DEC: diethyl carbonate) with a mass ratio of 1:1 was used as an electrolyte (1M-LiPF₆solution (manufactured by Ube Industries Ltd.)). After the electrolyte was infiltrated in the separator and the electrode film on the electrode foil, the product was contained in an aluminum-laminated film to manufacture a lithium ion secondary cell.

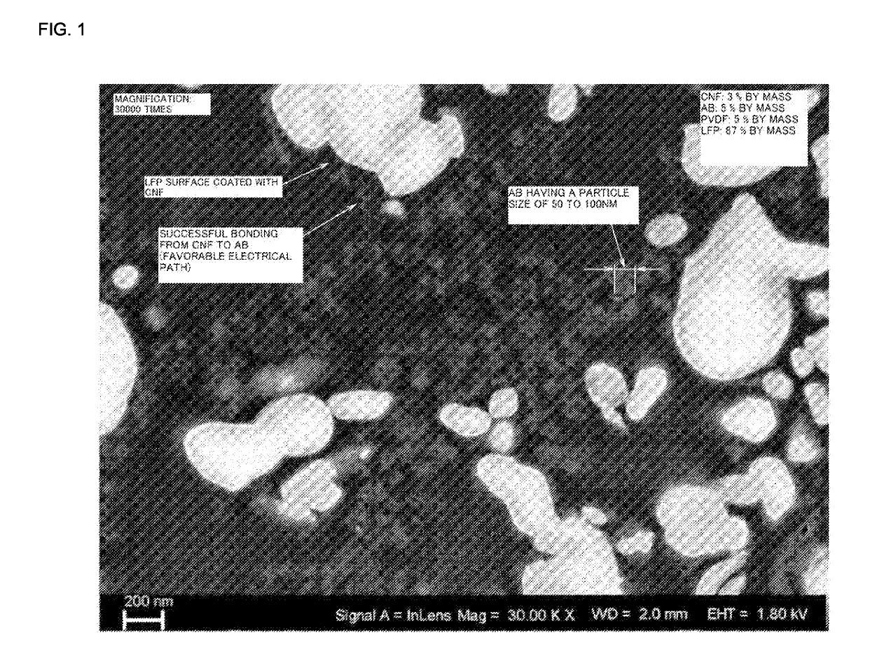

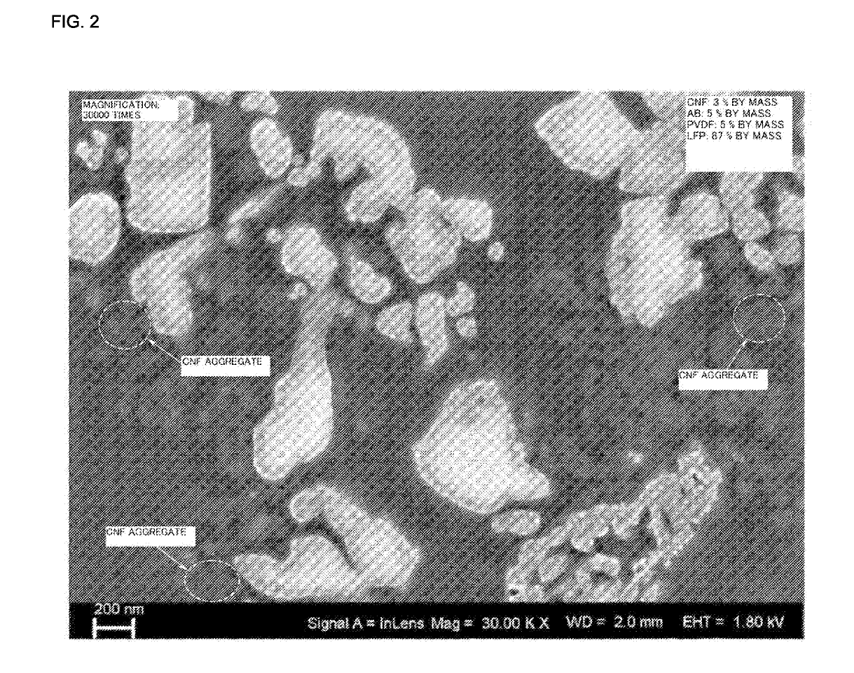

A pair of leads were connected to the positive electrode and the negative electrode of the above lithium ion secondary cell to measure a potential between the positive electrode and the counter electrode. As for the above lithium ion secondary cell, a charge-discharge cycle test was performed. Charge was performed under the condition of constant 0.2 C rate and at a voltage of 3.6V according to CC-CV method (constant current, constant voltage method), and discharge was performed under the condition of constant 5 C rate according to constant current method. Herein, C rate refers to charge-discharge rate. Specifically, 1 C rate charge discharge refers to the amount of current for discharging all cell capacity for 1 hour, and 2 C rate charge discharge refers to twice its amount of current. The test was performed at a constant temperature of 25° C. The cutoff voltage during discharge was a constant value at 2.0V. When the voltage was reduced to the potential, the measurement was halted before a specific duration of C rate. Also, whether an aggregate of a carbon nanotube (CNF) can be found or not was judged. In the method for judging the same, a square region (2.5 μm by 2.5 μm) at 3 optional electrode cross-sections were observed with an electronic microscope (SEM) with over 30,000 magnitude. When no aggregate 200 nm or more in diameter was found, the result was “none,” and one or more aggregates 200 nm or more in diameter were found, the result was “found.” The results are shown in the following Table 1. FIG. 1 shows part of cross-section of positive electrode of Example 1 taken by scanning electron microscope (SEM), and FIG. 2 shows part of cross-section of positive electrode of Comparative Example 1 taken by scanning electron microscope (SEM).

TABLE 1

| | conductive | | | | |
|---|---|---|---|---|---|
| | auxiliary agent | | | | |
| | | CNF | Discharge | Discharge | Decreasing |
| | | aggre- | capacity | capacity | rate of |
| | | gate is | after 1 | after 300 | discharge |
| | | found | cycle | cycles | capacity |
| | Type | or not | [mAh/g] | [mAh/g] | [%] |
| Exam- | CNF + AB | None | 131 | 120 | 8.4 |
| ple 1 | | | | | |
| Compar- | CNF + AB | Found | 131 | 75 | 43 |
| ative | | | | | |
| Exam- | | | | | |
| ple 1 | | | | | |
| Compar- | AB | — | 125 | 60 | 52 |
| ative | | | | | |
| Exam- | | | | | |
| ple 2 | | | | | |

As is evident from Table 1, in Comparative Examples 1 and 2, the discharge capacities after 300 cycles were significantly reduced to 75mAh/g and 60mAh/g, and the decreasing rates of the discharge capacity were high at 43% and 52%. In Example 1, the discharge capacity after 300 cycles was slightly reduced to 120 mAh/g, and the decreasing rate of the discharge capacity was small at 8.4%. In Comparative Example 1, the decreasing rate of the discharge capacity was high at 43%. This is probably because the mixed powder was insufficiently stirred in a binder paste so that each powder of the acetylene black (AB), the carbon nanofibers (CNF) and the positive electrode active material (LiFePO₄) was simultaneously added, and as shown in FIG. 2, the carbon nanofibers (CNF) were not secured to the surface of the active material and a resulting aggregate was scattered in the electrode film, thereby reducing the conductivity of the positive electrode. In Comparative Example 2, the decreasing rate of the discharge capacity was high at 52%, because the positive electrode active material (LiFePO₄) and the aluminum foil (current collector) were electrically connected by the less conductive acetylene black (AB) than the carbon nanofibers (CNF). Meanwhile, in Example 1, the decreasing rate of the discharge capacity was small at 8.4%, because the mixed powder was sufficiently stirred so that each powder of the acetylene black (AB), the carbon nanofibers (CNF) and the positive electrode active material (LiFePO₄) was simultaneously added in the binder paste. As shown in FIG. 1, the carbon nanofibers (CNF) did not become an aggregate, and were secured to a surface of the active material to coat a surface of the active material. The carbon nanofibers (CNF) electrically crosslinked the positive electrode active material (LiFePO₄) and the acetylene black (AB) to prepare a significantly favorable electrical path and thus improve the conductivity of the positive electrode.

### Example 2

An LiCoO₂(LCO) was used as a positive electrode active material. Other conditions were the same as in Example 1 to manufacture a positive electrode. The positive electrode was taken as Example 2.

### Example 3

An LiMn₂O₄(LMO) was used as a positive electrode active material. Other conditions were the same as in Example 1 to manufacture a positive electrode. The positive electrode was taken as Example 3.

### Example 4

An LiNiO₂(LNO) was used as a positive electrode active material. Other conditions were the same as in Example 1 to manufacture a positive electrode. The positive electrode was taken as Example 4.

### Example 5

An Li(MnₓNi_{y}CO_{z})O₂ was used as a positive electrode active material. Other conditions were the same as in Example 1 to manufacture a positive electrode. The positive electrode was taken as Example 5. X, Y and Z in the Li(MnₓNi_{y}Co_{z})O₂ were ⅓.

### Comparative Test 2 and Evaluation

Using the positive electrodes of Examples 1 to 5, in the same manner as in Comparative Test 1, a lithium ion secondary cell was manufactured and a charge discharge test was performed. Table 2 shows the results.

TABLE 2

| | | | | Dis- | Dis- | De- |
|---|---|---|---|---|---|---|
| | | | | charge | charge | creasing |
| | Positive | conductive | | capacity | capacity | rate of |
| | electrode | auxiliary agent | | after 1 | after 300 | discharge |
| | active | | CNF | cycle | cycle | capacity |
| | material | Type | Aggregate | [mAh/g] | [mAh/g] | [%] |
| Example | LiFePO₄ | CNF + | None | 131 | 120 | 8.4 |
| 1 | (LFP) | AB | | | | |
| Example | LiCo0₂ | CNF + | None | 125 | 109 | 13 |
| 2 | (LCO) | AB | | | | |
| Example | LiMn₂O₄ | CNF + | None | 101 | 93 | 7.9 |
| 3 | (LMO) | AB | | | | |
| Example | LiNi0₂ | CNF + | None | 173 | 156 | 9.8 |
| 4 | (LNO) | AB | | | | |
| Example | Li (Mn_{X}Ni_{Y} | CNF + | None | 146 | 132 | 9.6 |
| 5 | Co_{Z})0₂ | AB | | | | |
| | X, Y, Z = 1/3 | | | | | |

As is evident from Table 2, even if the positive electrode active material is replaced, the cell discharge capacity after 300 cycles of Examples 1 to 5 was slightly reduced to 93 to 132 mAh/g. The decreasing rates of the cell discharge capacities of Examples 1 to 5 were small at 7.9 to 13% to obtain stable cycle characteristics.

### Example 6

The stirring duration of a paste for an electrode with a homogenizer that acts a shearing force was changed to 5 seconds and the coating ratio by the carbon nanofibers (CNF) of the positive electrode active material (LiFePO₄(LFP)) surface was 10%. Other conditions were the same as in Example 1 to manufacture a positive electrode. The positive electrode was taken as Example 6. Aggregate of the carbon nanofibers (CNF) was not generated in the electrode film of the positive electrode. Herein, the coating ratio was determined by analyzing an electrode cross-section and finding the ratio of the surface of the active material coated with the carbon nanofibers by image processing in an electrode containing the carbon nanofibers. In the image processing, the surface of the active material is displayed in black and white parts: a white part in which the carbon nanofibers (CNF) were adhered and a black part in which carbon nanofibers (CNF) were not adhered to determine the coating ratio. The number of active material samples was 30 and the coating ratio was calculated as the arithmetic average of the coating ratios of the carbon nanofibers around the active materials.

### Example 7

The stirring duration of a paste for an electrode with a homogenizer that acts a shearing force was changed to 10 seconds and the coating ratio was 32% by the carbon nanofibers (CNF) of the positive electrode active material (LiFePO₄(LFP)) surface. Other conditions were the same as in Example 1 to manufacture a positive electrode. The positive electrode was taken as Example 7. An aggregate of the carbon nanofibers (CNF) was not generated in the electrode film of the positive electrode.

### Example 8

The stirring duration of a paste for an electrode with a homogenizer that acts a shearing force was changed to 120 seconds and the coating ratio was 98% by the carbon nanofibers (CNF) of the positive electrode active material (LiFePO₄(LFP)) surface. Other conditions were the same as in Example 1 to manufacture a positive electrode. The positive electrode was taken as Example 8. An aggregate of the carbon nanofibers (CNF) was not generated in the electrode film of the positive electrode.

### Example 9

Each powder of a polyvinylidene fluoride (PVDF), an acetylene black (AB), carbon nanofibers (CNF) and a positive electrode active material (LiFePO₄ (LFP)) as a binder having an organic solvent as a solvent was simultaneously fed to a planetary mixer (HIVIS MIX Model 2P-03: Product manufactured by Primix Corporation). The mixed powder was stirred and mixed with a rotation speed and a revolution speed of 30 rpm and 72 rpm, respectively. An N-methylpyrrolidone (NMP) as an organic solvent was slowly added in 40% quantities relative to 100% of a required amount to carry out stiffening for 2 hours. Thereafter, an N-methylpyrrolidone (NMP) was slowly added to the above kneaded product in 60% quantities relative to 100% of a required amount to prepare a paste for an electrode. Other conditions were the same as in Example 1 to manufacture a sheet-like electrode. The electrode was taken as Example 9. A planetary mixer of HIVIS MIX Model 2P-03 was provided with two twisting blades. The internal diameter and depth of a container were 96. 6 mm and 90 mm, respectively, and the gap between the twisting blade and the container was 2 mm.

### Comparative Test 3 and Evaluation

Using positive electrodes of Examples 1, and 6 to 9 and Comparative Example 1, as in Comparative Test 1, a lithium ion secondary cell was manufactured and a charge discharge test was performed. Table 3 shows the results as well as the data of Example 1. The coating ratio by the carbon nanofibers (CNF) of the positive electrode active material (LiFePO₄(LFP)) surface of Example 1 was 54%. The positive electrode active material (LiFePO₄ (LFP)) surface of Comparative Example 1 was not coated with carbon nanofibers (CNF) at all, and the carbon nanofibers (CNF) were present in an electrode as an aggregate without bonding with the active material. Further, the coating ratio by the carbon nanofibers (CNF) of the positive electrode active material (LiFePO₄ (LFP)) surface was determined from the ratio of carbon nanofibers (CNF) that adhere to a positive electrode active material surface in a cross-section of the positive electrode.

TABLE 3

| | Coating | | | | | |
|---|---|---|---|---|---|---|
| | ratio of | | | | | |
| | Positive | | | | Dis- | |
| | electrode | | | | charge | De- |
| | active | | | Dis- | Capa- | creasing |
| | material | Conductive | | charge | city | rate of |
| | (LFP) | Auxiliary agent | | capacity | after | dis- |
| | surface | | CNF | after 1 | 300 | charge |
| | by CNF | | aggre- | cycle | cycles | capacity |
| | % | Type | gate | [mAh/g] | [mAh/g] | [%] |
| Example | 10 | CNF + | None | 130 | 98 | 25 |
| 6 | | AB | | | | |
| Example | 32 | CNF + | None | 130 | 107 | 18 |
| 7 | | AB | | | | |
| Example | 54 | CNF + | None | 131 | 120 | 8.4 |
| 1 | | AB | | | | |
| Example | 98 | CNF + | None | 132 | 121 | 8.3 |
| 8 | | AB | | | | |
| Example | 73 | CNF + | None | 133 | 116 | 13 |
| 9 | | AB | | | | |
| Compar- | 0 | CNF + | Found | 131 | 75 | 43 |
| ative | | AB | | | | |
| Example 1 | | | | | | |

As is evident from Table 3, in Comparative Example 1 in which the positive electrode active material (LiFePO₄(LFP)) surface was not coated with carbon nanofibers (CNF) at all (coating ratio: 0%), the decreasing rate of the discharge capacity after 300 cycles was high at 43%. On the other hand, in Examples 1 and 6 to 9 in which the coating ratio by the carbon nanofibers (CNF) of the positive electrode active material (LiFePO₄ (LFP)) surface was 10 to 98%, the decreasing rate of the discharge capacity after 300 cycles was small at 8.3 to 25%. Accordingly, Examples 1 and 6 to 9 were found to be capable of obtaining a stable cycle characteristic.

### INDUSTRIAL APPLICABILITY

The electrode of the present invention can be used for an electrode of a lithium ion cell, and the lithium ion cell can be used as a power source for each apparatus such as mobile phones. This international application claims a priority right based on Japanese Patent Application No. 2012-124914 filed on May 31, 2012, and an entire content of Patent Application No. 2012-124914 is incorporated in the present international application.

1. An electrode for a lithium ion secondary cell, comprising: a conductive auxiliary agent; a binder; and an active material, wherein said conductive auxiliary agent comprises carbon black and carbon nanofibers, wherein
the carbon nanofibers are configured to electrically crosslink said active material and the carbon black, and the carbon nanofibers coat part or all of a surface of the active material to be secured by the binder.

2. The electrode for a lithium ion secondary cell according to claim 1, wherein by defining the entire surface of the active material as 100%, 10 to 100% of a surface of the active material is coated with the carbon nanofibers, and the active material and the carbon black are electrically crosslinked by bonding the carbon black to the carbon nanofibers with which the surface of the active material is coated.

3. The electrode for a lithium ion secondary cell according to claim 1, wherein the carbon black is acetylene black.

4. The electrode for a lithium ion secondary cell according to claim 1, wherein the binder is polyvinylidene fluoride.

5. The electrode for a lithium ion secondary cell according to claim 1, wherein the active material is a positive electrode active material consisting of any one of LiCoO₂, LiMn₂O₄, LiNiO₂, LiFePO₄ and Li(MnₓNi_{y}CO_{z})O₂, wherein X, Y and Z in the Li(MnₓNi_{y}CO_{z})O₂ meet the following conditions: X+Y+Z=1 and 0<X<1, 0<Y<1 and 0<Z<1.

6. The electrode for a lithium ion secondary cell according to claim 1, wherein the active material is a negative electrode active material composed of graphite.

7. A method for preparing a paste for an electrode for a lithium ion secondary cell, comprising the steps of:
preparing a viscous binder paste by adding a solvent or a thickener to a binder;
dispersing each powder of carbon black, carbon nanofibers and an active material in the binder paste by simultaneously adding the each powder to the binder paste, by stirring the same with a mixer that acts no shearing force on the each powder and by further stirring the same with a homogenizer that acts no shearing force on the each powder; and
preparing a paste for an electrode by dispersing an aggregate of a residue of the each powder in the binder paste by stirring the same with a homogenizer that acts a shearing force on the each powder dispersed in the binder paste.

8. (canceled)

9. A method for manufacturing an electrode for a lithium ion secondary cell, comprising the steps of:
forming an electrode film on an electrode foil by applying a paste for an electrode prepared by the method according to claim 7 to the electrode foil;
forming the electrode film so as to have a constant thickness;
drying the electrode film formed to have a constant thickness; and
manufacturing a sheet-like electrode by pressing the dried electrode film.

10. (canceled)
